(19) United States
(12) Patent Application Publication
(10) Pub. No.: US 2004/0071141 A1
(43) Pub. Date: Apr. 15, 2004

(54) Distributed service architecture based on a hierarchical load balancing approach

(76) Inventors: Narendra Kumar Dhara, San Jose, CA (US); Elwin Stelzer Eliazer, San Jose, CA (US)

Correspondence Address: Pillsbury Winthrop LLP, 2550 Hanover Street, Palo Alto, CA, 94304-1115, US

(21) Appl. No.: 10/272,578

(22) Filed: Oct. 15, 2002

(51) Int. Cl. H04L 12/28

(52) U.S. Cl. 370/392

(57) ABSTRACT

An Enhanced Service Layer Mapping which is hierarchical and widely load balanced to derive an efficiently distributed architecture. At the top of the hierarchy, all the ports are grouped into SPG units and tightly coupled with the SSS unit. At the second level of the hierarchy, within a given SPG-SSS unit, the ports and subscribers are sub-grouped and tied to a sub-pool of PEs. At an even lower level of the hierarchy, subscribers and services are mapped and load balanced to a fixed PEs.

### BACKGROUND

1. Field of the Invention

The invention is generally related to networking equipment and services. More particularly, the invention is related to design and operation of packet handling networking equipment that support high speed interfaces.

2. Related Art

Because of the tremendous growth in the network services there is an emerging need for a new class of systems called Service Edge Routers or SER. Packet switching communications networks are viewed logically as having core networks, network edge and subscriber/access networks. One protocol for transmission of data over such networks is the IP (Internet Protocol) standard.

The network edge aggregates the packet traffic received from subscriber/access networks and forwards such traffic to the core networks. The network edge serves as an interface between subscribers and the core networks, which are the backbone networks that function over long distances such as those networks administered by major telecommunications carriers. Network Edge often contain “routers” which are devices that determine what network path particular packets should take going forward given their intended destination, state of the network, packet size etc. SERs, or Services Edge Routers have become increasingly popular due to the growth in demand and deployment for network services. SERs are network devices or systems that are deployed at the boundary of the service provider's core network. SERs aggregate traffic from subscribers and groom such traffic for use in services before routing the traffic elsewhere.

The architectural problem with conventional service edge routers can be decomposed as follows. The system supporting the above-mentioned applications will have the following characteristics:

Multiple physical ports attached;

Each of the physical ports has IP traffic belonging to multiple subscribers;

Each of the subscriber has multiple IP flows;

Each or a group of IP flows require a set of similar services processing requirements; and

The system also has an operational interface function through which it is managed and deployed in a network.

As IP traffic goes through the ports attached to the system, the packets go through a series of functional blocks as shown in FIG. 1.

As packet enters the system, first its identification and association with a subscriber is established (block 110). Based on the services signed up by the subscriber the service profile is pulled out for that packet (block 110). The packet then goes through service processing functional blocks (block 120) before it goes out of the system through an egress port. A service can be as simple as a route lookup and forwarding to a complex function such as a firewall or VPN (Virtual Private Network). A service in the above definition is also expanded to a combination of services where a packet goes through multiple service processing functions (block 120) before it leaves the Service Edge Router. FIG. 1 provides a problem definition for designing a Service Edge Router. A system designer will have to consider a set of service processing functional blocks which are designed to process the packet in a particular way. The system can be viewed as a pool of functional blocks that together perform all the service processing functions for all the IP flows in the service edge router. Each architecture approach will have a unique mapping and partitioning of functional blocks. The flexibility and benefits of the architecture will depend upon:

What type of functional blocks are selected and what processing functions are mapped or performed on these functional blocks, and

How the incoming IP flows and the associated set of subscribers and ports are grouped and processed by the functional blocks.

In a service edge router, the service processing functions are implemented using a collection of “processing elements” interconnected in a particular way. The processing elements are basic processing units that operate on data or other packets. The interconnection between the various processing elements allow for packet to move through the several processing functions within the system. The architectural design goal is ordinarily to map these Service functional blocks 120 onto processing elements thereby resulting in a design that provides scalability and performance. In addition such a design lends itself to easy addition of new type of services.

The following are some of the relevant elements of the SER:

Physical ports

Subscribers

IP flows

Service Type

A group of physical ports are typically bound to a physical entity in a system, such as the well-known line card (LC). Each of the physical ports in the system will have multiple subscribers associated with it. And each of the subscribers can have multiple IP flows associated therewith. An IP flow can be defined as a flow of packets or data-grams that have unique source and destination. The system supports multiple Service type. For example, some of the different service types could be as follows:

Routing

Virtual Private Network or Tunneling mechanisms

QOS (Quality of Service)

Firewall

Security

NAT (Network Address Translation)

A Service Type and the associated processing can be represented as layers within the services. Each service has three distinct layers of processing—one for processing data plane packets, one for control plane packets and the other for management layer. Hence a service is decomposed into three layers of processing—control plane layer, data plane layer and management layer. In a typical SER, the management plane of all service types collapses into one System operational layer.

A high level functional representation of the system with different service layers identified is shown in FIG. 2. Each service supported by the system is layered into two main parts. In addition, the overall system has a consolidated operational and management layer 230. A group of physical ports and associated subscribers are together termed “Subscriber and Port Groups” or SPGs. Usually SPGs are defined based on the association of a set of physical ports binding to a hardware element such as a Printed Circuit Board or PCB. The design unit that physically binds this grouping is called SPG unit. For example, all the ports in a line card in a system can be considered as being grouped into one SPG unit. In more general terms, an SPG is a set of physical ports and all the subscribers whose traffic traverses through that set of physical ports. Hence, an SPG can be viewed as a group of physical ports and their associated subscribers.

The key functional block that processes a set of service layers is called a Processing Element. The processing element could consist of hardware-based and/or software-based processing sub-elements. Processing Elements are characterized by the fact that they can perform general purpose or application specific packet processing entirely in hardware or software or a combination of both. An example is an encryption processor where packet processing is done in both hardware and software. The system design involves a mapping of functional service layers into a combination of processing elements using unique portioning methods. Different mapping techniques will result in different designs with unique system capabilities. FIG. 3 illustrates a conventional mapping approach.

In this approach, all the ports and associated subscribers are aggregated into multiple SPG units. A common Services Sub System (SSS) 320 is designed with a group of PEs (Processing Elements). The SSS is a logical sub-system within the SER where a pool of Processing Elements are grouped together. A Processing Element is thus a design unit that could process one or more of the service layers. SSS 320 is shown for example as consisting of five PEs 320a, 320b, 320c, 320d and 320e. A Hardware based Encryption ASIC (Application Specific Integrated Circuit) is an example of hardware and software based Processing Element that is designed to encrypt and decrypt packets for secure service. A general-purpose processor like a CPU is an example of Processing Element that also has both hardware and software processing components. Many of the service layer functions can be processed in the CPU. The physical design entity that binds the PEs belonging to a SSS is called an SSS unit.

Assume that in the system/router, the service requirements are for traffic originating from M SPG units is processed in a set of common N SSS units. In this case, there will be M SPG units and N SSS units in the system.

In addition to the SSS unit 320, there is a single Operational Sub System which has a single PE not shared by the SSS 320. The physical entity that binds these processing elements in the OSS is called the OSS unit. In this conventional approach, a translation from the functional to the actual physical design is achieved by:

Mapping of all Data plane layer and control plane layer for all Service Types into every PE in all of the SSS units. This means that every PE will have the functionality to process all service layers that the system can support; and

Mapping the system operation layer is mapped into the single PE in the OSS unit.

As packets belonging to the grouped M SPG units come into the system they enter a load balancing system 305, which will determine which PE in the N SSS units is available to process the next packet. The load balancing system 305 will maximize the processing capacity of the N SSS units by distributing traffic within the SPG units based on ports and to some extent subscribers. The packets are then switched to their associated set of N SSS units. With this conventional approach, the system 305 cannot perform load balancing based on Service Type. The system switch 310 illustrated in FIG. 3 will switch packets between different SPG and SSS units. No scalability or performance of services can be obtained. Also as the percentage of subscribers needing services grow within an SPG, the performance out of each of SSS becomes non-deterministic. Further, the conventional approach cannot extend itself to be load balanced to IP flows within a subscriber's traffic. This functional layer partition and the mapping explained above will results in an architecture 400 as illustrated in FIG. 4.

Given this architecture, it can be readily observed that the SSS unit is a shared unit among several SPG units. The SPG unit is not dedicated. Because of this as the number of SPG units grow in the system, the performance from the available set of SPG units will come down. This effects the overall performance of the system. Also each of PE processes all or some of the Service Layer functions. Due to this the design of PE cannot be tuned for a specific processing layer but rather will be flexible to perform many functions. Since most of the packets require more than one service processing and the packet throughput from a single PE processing will be degraded.

### SUMMARY

The Enhanced Service Layer Mapping which is utilized in one or more embodiments of the invention results in a unique architecture that is highly scalable and can give improved performance. The Enhanced Service Layer Mapping is hierarchical and widely load balanced to derive an efficiently distributed architecture.

At the top of the hierarchy, all the ports are grouped into SPG units and tightly coupled with the SSS unit. At this level, there is a one to one association of an SPG unit to an SSS unit. In addition the SPG unit and SSS unit are coupled and implemented in one single physical PCB. This physical entity is called an SPG-SSS unit. Each of the SPG-SSS units will have a pool of PEs. All service layers that are required to process packets originating from an SPG-SSS units are bound to Processing Elements that are designed into the SPG-SSS unit. This will result in a distributed system architecture that is load balanced based on the SPG grouping.

At the second level of the hierarchy, within a given SPG-SSS unit, the ports and subscribers are sub-grouped and tied to a sub-pool of PEs. Each sub-pool or sub-group of PEs is called a Packet Services Block (PSB). Each of PSBs process packets from a subset of physical ports within the SPG-SSS units. The SPG-SSS typically consists of multiple PSBs.

At an even lower level of the hierarchy, subscribers and services are mapped and load balanced to a fixed PEs. Each of the PEs is dedicated to processing a single layer of a single type of service. For example the Data Plane layer of Service Type X is mapped into a PE and that PE performs only the Data Plane layer processing functions and only for the Service Type X. Multiple PEs may exist performing the same Data Plane layer functions for the same Service Type within this SPG-SSS unit. Each PE will carry only profiles of the service type it supports. Subscriber traffic traversing through a group of ports in the SPG for this unit will have a set of dedicated PEs performing service layer functions. In addition PEs are dedicated based on processing type. Since a pool of PEs are available to process a single type of service layer, Subscriber flows can be load balanced across these PEs within a SPG-SSS unit. Load balancing based on service layer type is also achieved with this mapping.

The Enhanced Service Layer Mapping Approach results in a scalable system that can have the following features and advantages:

Complete distribution of service processing on to the line cards or SPG-SSS units

Complete separation of data and control plane processing with in the system

Multilevel load balanced systems where the atomic group of ports and associated subscriber traffic is assigned to a PSB. The PSB is designed to performance and scalability. This guarantee of performance and scalability translate to overall system level performance and scalability.

Service level load balancing within a PSB where certain PEs are dedicated to process a particular service layer type.

The load balancing circuit at the PSB level can load balance not only based on ports and subscribers but also flows within a given subscriber.

### BRIEF DESCRIPTION OF DRAWINGS

FIG. 1 illustrates functional blocks and the system design problem for network services architecture;

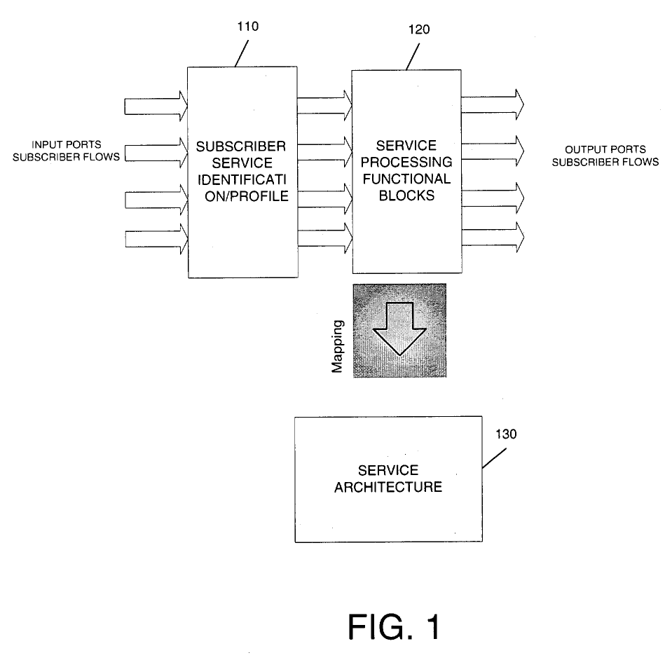

FIG. 2 illustrates different service layers in a network services device/system;

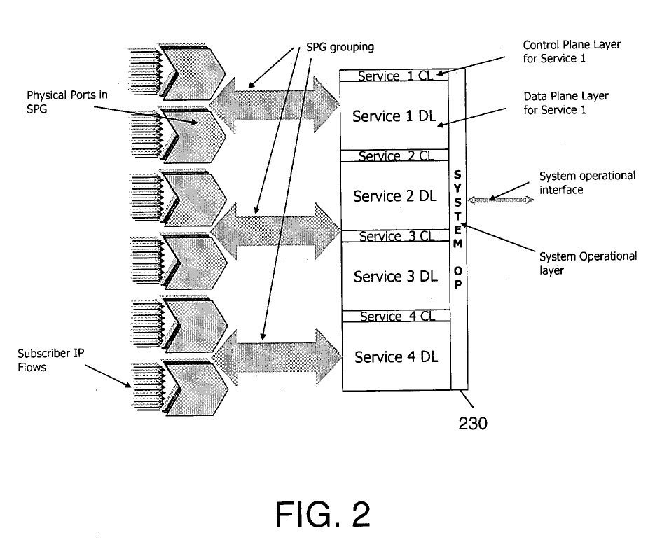

FIG. 3 illustrates a conventional mapping approach in a network services device/system;

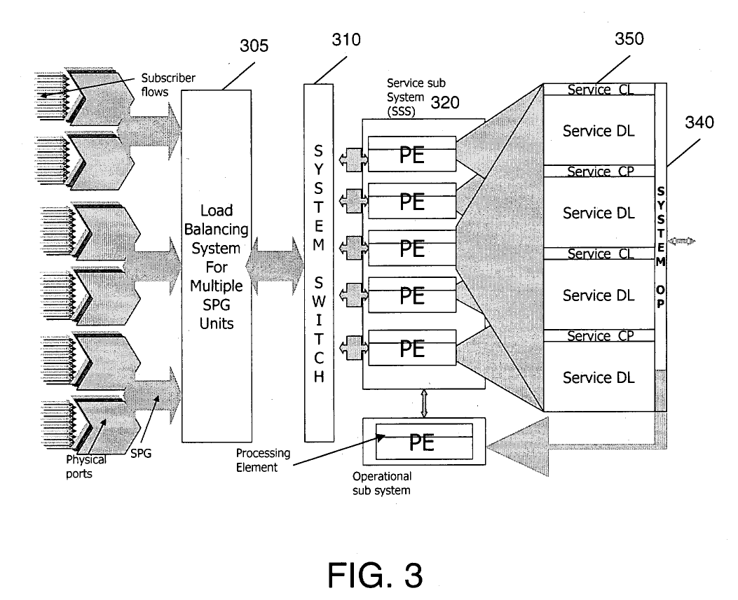

FIG. 4 illustrates the physical design of a network services system/device resulting from a conventional mapping approach such as that shown in FIG. 3;

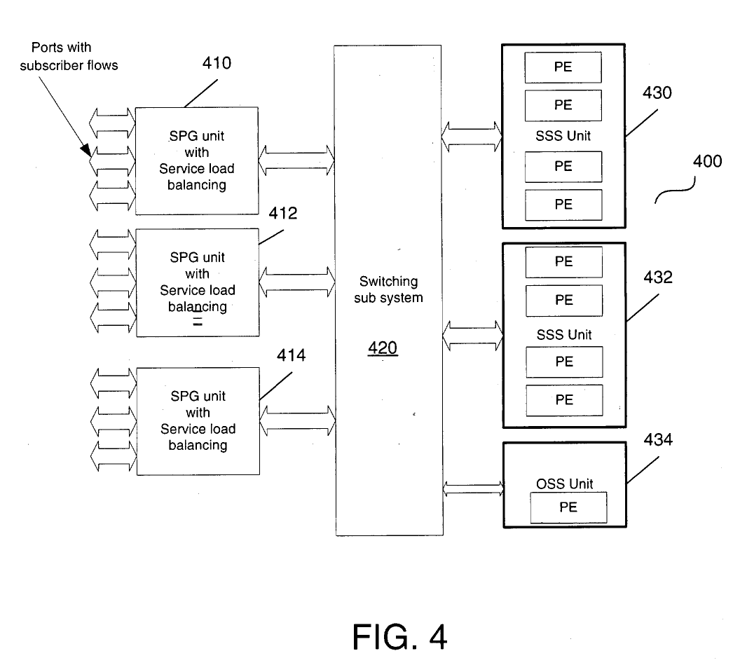

FIG. 5 illustrates the mapping hierarchy in relation to the architectural elements of the system according to at least one embodiment of the system;

FIG. 6 illustrates the functional and physical design resulting from/embodying the mapping approach described in FIG. 5;

FIG. 7 illustrates an exemplary SPG-SSS unit circuit according to at least one embodiment of the invention; and

FIG. 8 illustrates the distributed nature of one or more embodiments of the invention.

### DETAILED DESCRIPTION

The mapping used in the invention results in a unique architecture that is highly scalable and can give improved performance. The mapping is an enhanced Service Layer Mapping, which is hierarchical and widely load balanced and is used to derive an efficiently distributed architecture.

The Enhanced Service Layer Mapping Approach results in a scalable system that can have the following features and advantages:

Complete distribution of service processing on to the line cards or SPG-SSS units

Complete separation of data and control plane processing with in the system

Multilevel load balanced systems where the atomic group of ports and associated subscriber traffic is assigned to a PSB. The PSB is designed to performance and scalability. This guarantee of performance and scalability translate to overall system level performance and scalability.

Service level load balancing within a PSB where certain PEs are dedicated to process a particular service layer type.

The load balancing circuit at the PSB level can load balance not only based on ports and subscribers but also flows within a given subscriber.

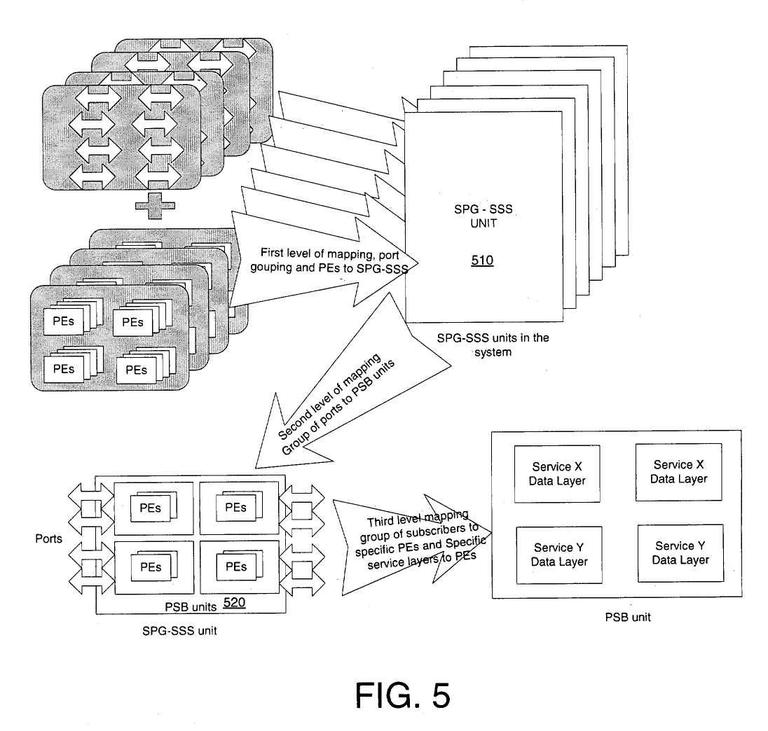

The mapping hierarchy in relation to the architectural elements of the system is shown in FIG. 5. At the top of the hierarchy (i.e. in the “first” level of mapping), all the ports are grouped into SPG units and tightly coupled with the SSS unit. At this level, there is a one to one association of an SPG unit to an SSS unit. In addition the SPG unit and SSS unit are coupled and is implemented in one single physical PCB. This physical entity is referred to herein as an SPG-SSS unit. FIG. 5 shows a number of SPG-SSS units 510. Each of the SP-GSSS units 510 will have a pool of associated PEs. All service layers that are required to process packets coming from an SPG-SSS units are bound to Processing Elements that are designed into the SPG-SSS unit. This will result in a distributed system architecture that is load balanced based on the SPG grouping.

At the second level of mapping (hierarchy), within an SPG-SSS unit, the ports and subscribers are sub-grouped and tied to a sub-pool of PEs. This sub pool or sub-group of processing elements is called a Packet Services Block or PSB. FIG. 5 show a group of PSBs 520. Each of the PSBs 520 processes packets from a subset of physical ports within the SPG-SSS units 510. The SPG-SSS typically consists of multiple PSBs.

At the lower or third level of mapping, subscribers, services and layers are mapped and load balanced to a fixed set of PEs. Each of the PEs is dedicated to process a single layer in a single type of service. For example, the Data Plane layer of service type X is mapped into a PE and that PE performs only the Data Plane layer processing functions. Multiple PEs may exist performing the same Data Plane layer functions within this SPG-SSS unit. Each PE will carry only profile of the service type it supports. Subscriber traffic incoming on a group of ports in the SPG for this unit will have a set of dedicated PEs performing service layer functions. In addition, PEs are dedicated based upon processing type. Load balancing based on service layer type is also achieved with this mapping.

As traffic enters a SPG-SSS unit, a Packet Dispatcher circuit on the SPG-SSS unit will, based on service profile of the packet, will perform sequencing functions among different PEs. It will also perform implicit load balancing based on the following criteria—ports, subscribers and/or IP flows belonging to a subscriber. Further load balancing can be done based on service layer type. Due to the one-to-one association of SPG to SSS, traffic enters the system switch only after all the service processing is completed. The system components primarily consist of SPG-SSS units. As packets enter the system, service processing is performed closer to the physical interfaces. Hence all the service processing functions are processed near the physical interface units or SPG-SSS unit and there is no central unit in the system where the packet has to travel to for the services. This results in a system architecture that is distributed. The SPG-SSS unit is the element where the system wide processing function is distributed and by design has all the processing capacity (PEs) to handle the traffic from the unit's SPG.

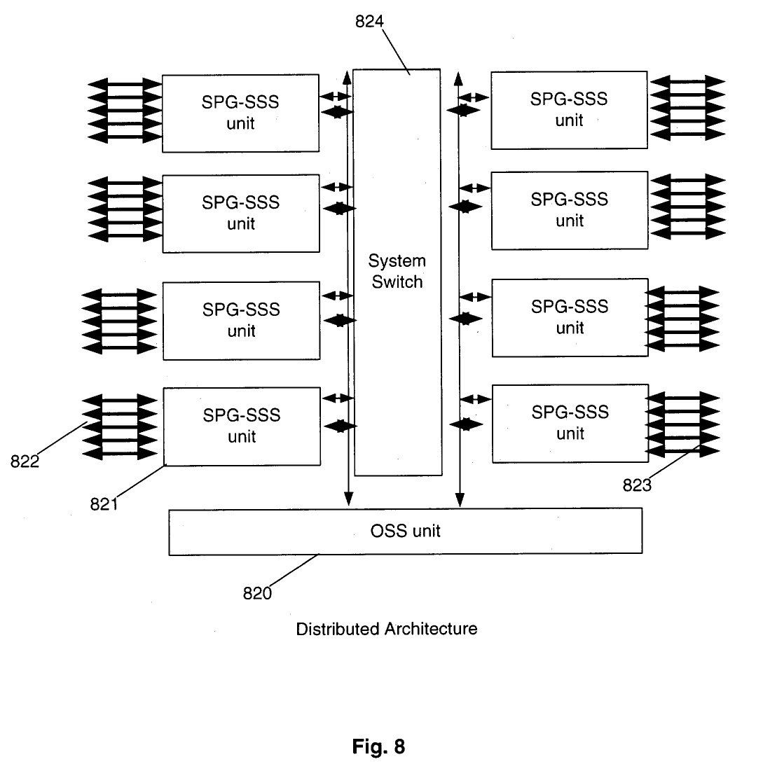

FIG. 8 illustrates the distributed nature of one or more embodiments of the invention. The system design consists of SPG-SSS units identified by 821. Each of the SPG-SSS unit will have a group of physical ports and associated subscribers identified by 821. Each of the SPG-SSS unit has enough processing elements to process all the service layer functions that the SER supports for the packets entering the unit. Thus, the overall service processing in the system is distributed into these SPG-SSS units with their own set of PEs. This results in a distributed architecture. Packets entering ingress SPG-SSS unit 821 will go through all the required service processing functions and will switch through the system switch 824 before going out of the system on the egress SPG-SSS unit 823. Within an SPG-SSS unit, the packets are load balanced across several PEs. In FIG. 5, the SPG-SSS unit is designed to load balance in the incoming traffic. The set of PEs in the SPG-SSS unit are grouped into Packet Services Block 520. Each of the PSBs will process packets from a set of ports on the SPG-SSS unit. Within the PSB 520, multiple PEs are designed to process specific service layer function. The packets directed to a PSB 520 are further load balanced based on subscribers, subscriber flows and services into a subset of PEs doing similar functions.

The resulting design has an the following characteristics:

Hierarchical load balancing:

Load balancing based on a group of ports in the system with processing for that group done in a SPG-SSS unit;

port-based load balancing within the SPG-SSS unit into multiple groups of PEs; and

subscribers and services within a port are load balanced into sub-groups of PEs.

Service layer load balancing:

Within and SPG-SSS unit, the design also performs load balancing based on a service layer type. For example, all traffic (irrespective of ports and subscribers in the SPG-SSS unit) can be load balanced across available set of PEs dedicated for that service layer.

Distributed Processing:

The system design is distributed in terms of service processing functions due to the coupling between the SPG and SSS. All the service processing functions for packets coming into the system are handled in the local SPG-SSS unit and the packet does not have to travel to a central unit in the system for services. The SPG-SSS unit is a distributed element.

Distribution is achieved due to flexible mapping and sequencing of Processing Elements.

SPG grouping is based on a grouping of ports that go on a line card.

Complete separation of Control layer processing from data plane layer processing and Operation layer processing.

Implicit load balancing

By design ports and subscribers have a dedicated set of PEs for processing.

The switching sub system on the SPG-SSS unit will implicitly load balance the traffic to appropriate group of PEs.

Modular design

The invention also employs a modular design approach where a sub-set of processing elements that are processing a specific service type are designed in a daughter card. If the system is deployed in the network where this service is not needed, the daughter cards are not populated. This approach will provide a means of providing different feature configuration options for the same architecture.

The invention in various embodiments serves to divide the design problem into smaller problems and does a unique mapping of service layer functions to PEs with a combination of hierarchical load balancing and also dedicated service layer processing. In this approach, the resulting service processing functions on the IP packets are performed locally within the ingress SPG-SSS unit. All the SPG-SSS units in the systems will have all the service processing functions for a group of subscribers and ports. The packets do not have to traverse through the fabric to another central and shared unit for service processing. Thus the system/SER now primarily has SPG-SSS units which are designed to process all the service processing functions that the system supports, but only to a subset of subscribers and ports. This results in a totally distributed architecture.

The potential advantages of this design, which is the subject of the invention, are:

Fundamentally, by assigning PEs to process only a specific layer type, the PE design can be optimized to both performance and scalability

Within the system, service processing within an SPG-SSS unit is not shares across multiple SPG units. Service processing is also not shared within the sub-groups in a given-SPG-SSS unit.

All processing resources are dedicated and private.

Each SPG-SSS unit is designed to perform and scale to support the physical ports and subscriber traffic that come with the SPG. Thus, performance and scalability is guaranteed to unaffected due to the isolation of processing functions belonging to other SPG-SSS units.

For process intensive service layers service load balance is supported within an SPG-SSS. This hierarchical approach to service process results in dedicated resources for a subset of traffic and ensuring enough processing cycles

The distributed architecture with SPG-SSS units lends to different applications easily. If a new service type is required to be added for a new application, a newly designed SPG-SSS unit with that particular service support can be readily integrated into the an existing system deploying the invention.

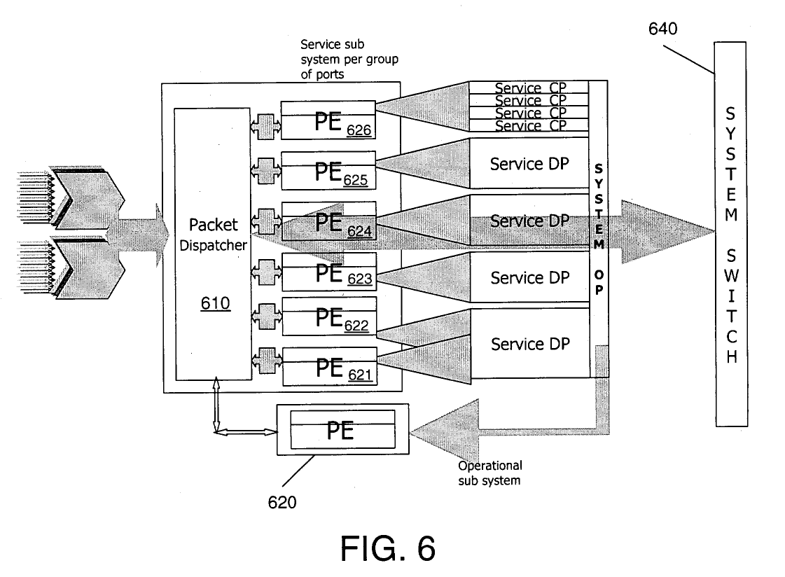

FIG. 6 illustrate the functional and physical design resulting from/embodying the mapping approach described in FIG. 5. A Packet Dispatcher circuit 610 is coupled to a plurality of PEs 621, 622, 623, 624, 625 and 626. A separate PE is included as part of an OSS (operational sub-system) unit 620 which handles System operational plane processing. Finally a Packet Dispatcher Circuit 610 is included that provides connectivity between all the PEs that also performs the sequencing of the packet between various PEs. There is one dedicated PE 626 shown in FIG. 6 where all the Control Plane layer processing for all the service types is performed. In other embodiments, the design could extend this mapping to have multiple PEs where the control plane processing for a specific set of service types are processed. All the remaining PEs 621, 622, 623, 624, and 625 process dedicated Data Plane processing functions for a specific service type. All the PEs in the SPG-SSS unit are connected via the Packet Dispatcher circuit 640. In addition, the Packet Dispatcher circuit 610 will connect to a OSS unit 620 where a dedicated PE exists for operational layer processing functions. Once processing of packets is completed they may be forwarded to a system switch 640 for re-routing to other system cards and elements.

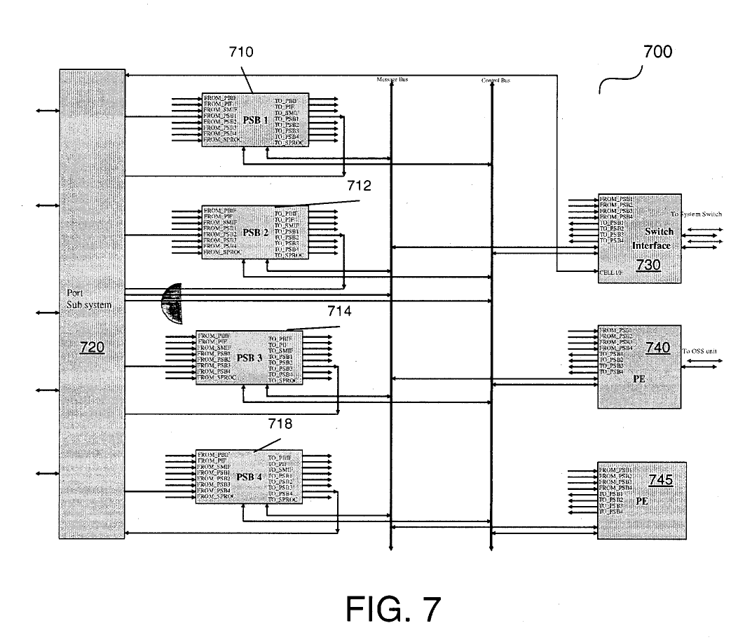

FIG. 7 illustrates an exemplary SPG-SSS unit circuit according to at least one embodiment of the invention. The SPG-SSS Unit 700 can be configured so as to carry out the enhanced service layer mapping described above. Unit 700 consists of a group of four PSBs (Packet Services Blocks) 710, 712, 714 and 718 as well as a Packet Dispatcher circuit 720. There is also provided a switch interface 730 and a pair of PEs 740 and 745. When a packet enters the system, on the ingress SPG-SSS unit 700, the Packet Dispatcher 720 performs load balancing and determines the order of service processing. A set of PEs in a given PSB are dedicated to provide service layer functions for a set of IP flows that belong to a subset of subscribers and physical ports. The Packet Dispatcher 720 load balances the ingress IP flows into a set of PEs based on the above-mentioned criteria. After each PE completes processing of the packet, the packet dispatcher then sequences the packet to other appropriate PEs within a given PSB for subsequent service processing. If the packet requires a control layer processing or an operational layer processing, it is send to the specific PE or the OSS unit respectively. Once the packet goes through all the Service layer processing, it then goes to the system switch via the switch interface 730 and exits the system through an egress SPG-SSS unit.

The present invention has been described above in connection with a preferred embodiment thereof; however, this has been done for purposes of illustration only, and the invention is not so limited. Indeed, variations of the invention will be readily apparent to those skilled in the art and also fall within the scope of the invention.

What is claimed is:

1. A system comprising:
a first level of mapping, said first level grouping ports and processing elements into a plurality of SPG-SSS units such that each said SPG-SSS unit is associated with a pool of said processing elements dedicated to processing packets belonging to said SPG-SSS unit with which it is associated;
a second level of mapping, said second level mapping said ports and subscribers whose traffic belongs to said ports to PSB units within each of said SPG-SSS units; and
a third level of mapping, said third level of mapping grouping subscribers to specific said processing elements and grouping service layers to specific said processing elements.

2. A system according to claim 1 wherein each said PSB unit consists of a plurality of said processing elements.

3. A system according to claim 1 wherein each said SPG-SSS unit consists of a plurality of PSB units.

4. A system according to claim 1 wherein said service layers consist of data plane and control plane service layers, each of said data plane and control plane service layers handled by different processing elements.

5. A system according to claim 1 wherein said system load balances packets across said processing elements, across said PSBs, and across said SPG-SSS units based upon which ports and subscribers such packets belong to.

6. A system according to claim 5 wherein said system is further configured to also load balance IP flows across said processing elements and said PSBs, said IP flows belonging to packets bound to the same subscribers.

7. An apparatus comprising:
a packet dispatcher, said packet dispatcher; and
a plurality of processing elements, all processing elements coupled to and accepting packets from said packet dispatcher, each of a first group of said processing elements dedicated to handling a particular service data plane, and each of a second group of said processing elements dedicated to handling at least one service control plane.

8. An apparatus according to claim 7 wherein said first group includes processing elements that each exclusively handle the processing for a particular service data plane.

9. An apparatus according to claim 7 wherein said first group includes processing elements that share handling of the same service data plane.

10. An apparatus according to claim 7 wherein said second group consists of a single processing element that handles all service control planes.

11. An apparatus according to claim 7 wherein said second group consists of a plurality of processing elements handling all service control planes in a distributed manner.

12. An apparatus according to claim 7 further comprising a third group of processing elements, said third group of processing elements coupled to said packet dispatcher, said third group of processing elements handling the system operational plane.

13. An apparatus according to claim 7 wherein said apparatus is coupled to a system switch for communicating packets processed through said apparatus to other system devices.

14. An apparatus according to claim 7 wherein said packet dispatcher is configured to load balance incoming packets onto said processing elements.
